(19) United States
(12) Patent Application Publication
(10) Pub. No.: US 2025/0124104 A1
(43) Pub. Date: Apr. 17, 2025

(54) TENSOR CORES FOR ONE-SIDED UNSTRUCTURED SPARSITY

(71) Applicant: Purdue Research Foundation, West Lafayette, IN (US)

(72) Inventors: Mithuna Shamabhat Thottethodi, West Lafayette, IN (US); Terani N. Vijaykumar, West Lafayette, IN (US)

(73) Assignee: Purdue Research Foundation, West Lafayette, IN (US)

(21) Appl. No.: 18/914,084

(22) Filed: Oct. 12, 2024

Related U.S. Application Data
(60) Provisional application No. 63/544,152, filed on Oct. 14, 2023.

(51) Int. Cl. G06F 17/16

(52) U.S. Cl. CPC G06F 17/16

(57) ABSTRACT

A method for multiplying a sparse matrix (SM) with a full matrix, includes receiving a SM, left aligning each row based on a maximum number of non-sparse cells in each said row, generating a left aligned matrix, displacing at least one cell from an original row into another row of the left aligned matrix to thereby generate at least one new sparse column in said SM to thus reduce sparsity by discarding said at least one new sparse column, thus generating a critical-path-reduced matrix, and wherein the at least one displaced cell includes a flag identifying said cell has been displaced from the original row in the SM, and multiplying the critical-path-reduced matrix with the full matrix using a multiplier, wherein the product from each cell having a displacement flag is moved and accumulated to an accumulator within the multiplier associated with remainder of data for said original row.

### CROSS-REFERENCE TO RELATED APPLICATIONS

The present non-provisional patent application is related to and claims the priority benefit of U.S. Provisional Patent Application Ser. 63/544,152, filed Oct. 14, 2023, the contents of which are hereby incorporated by reference in its entirety into the present disclosure.

### STATEMENT REGARDING GOVERNMENT FUNDING

None.

### TECHNICAL FIELD

The present disclosure generally relates to hardware improvements used in deep neural network applications, and in particular to hardware improvement for matrix multiplication with unstructured sparsity.

### BACKGROUND

This section introduces aspects that may help facilitate a better understanding of the disclosure. Accordingly, these statements are to be read in this light and are not to be understood as admissions about what is or is not prior art.

Deep neural networks (DNNs) are deployed widely for many commercial applications including image classification, recognition, natural language processing, and recommendation systems. To meet the high compute demand of many of the models, commercial DNN accelerators (e.g., the graphical processing unit (GPU) and tensor processing unit (TPU)) provide energy and area-efficient hardware with vast compute and memory bandwidth resources. TPUs use large two-dimensional systolic arrays whereas GPUs use specialized compute units, called tensor cores, optimized for dense matrix multiplication.

A DNN has many layers, where each layer's output is generated using operations such as convolutions, matrix multiplication, and non-linear operations (e.g., ReLU). Convolutions and matrix multiplications are compute-intensive and consume time and energy. Convolutions can be transformed into matrix multiplication using implicit General Matrix Multiplication (GEMM) kernels without image into the columns of a matrix (IM2Col) memory bloat.

Despite such specialized units, the demand for compute continues to outpace the hardware as models grow in size and complexity. Sparsity, or zeros in the input matrices, can help meet this demand. Sparsity occurs in the filters due to pruning coupled with retraining for accuracy. Sparsity in the filters and activations could be structured with hardware-friendly patterns or unstructured without constraining the location of zeros. For instance, according to one approach in the prior art, structured 2:4 sparsity (i.e., two out of four filter values are non-zeros and fewer than two non-zeros treated as two non-zeros for regularity), leads to 2× better performance and nearly 2×better energy over dense (capturing sparsity incurs some modest energy and area overhead). By reducing work, sparsity improves both performance and energy. Due to its uniform 50% sparsity, 2:4 sparsity does not incur load imbalance or compute under-utilization so that the tensor cores maintain (input or output) operand stationarity, similar to dense operation, which is fundamental for avoiding high-overhead hardware. Consequently, the tensor cores add only one 4-1 multiplexor per multiply-accumulate unit (MAC) for 2:4 sparsity. This minimal extra hardware results in the tensor cores being highly efficient for both 2:4 sparse and dense operations.

Unstructured sparsity, on the other hand, can be much higher (e.g., 83%) without loss of accuracy. Capturing unstructured filter sparsity alone (i.e., one-sided) would achieve 5-6× speedup and possibly 4-5× lower energy after accounting for sparsity overheads over dense (at modest area overhead). Increasing 2:4 sparsity from its 2× limit to this level would result in loss of accuracy. Further, sparsity can also occur in the feature maps for some DNNs due to the presence of non-linear layers such as ReLU which zeroes out negative values. Such feature map sparsity, which is necessarily unstructured, can range up to 50%. Exploiting both filter and feature map (i.e., two-sided) sparsity can achieve further improvements. However, unstructured sparsity incurs load imbalance due to its non-uniformity.

To achieve load balance and high compute utilization, prior art approaches targeting one- or two-sided unstructured sparsity incur considerable hardware overhead due to the added costs of buffering, routing, and sparse computation. As such, it is difficult to scale up these proposals to the high compute throughputs of commercial accelerators such as GPUs. In addition, these custom sparse accelerators cannot process dense matrices as efficiently as the GPU and TPU which is important for unpruned, dense models that continue to be used. Any unstructured sparse operation must satisfy the tensor cores' challenging constraint of minimal extra hardware (and hence energy and area). Unfortunately, previous tensor core-specific proposals violate this key constraint by adding crossbars, accumulation buffers, and scatter-gather logic, mostly due to sacrificing operand stationarity in favor of load balance.

Therefore, there is an unmet need for a novel method and hardware that can improve matrix multiplication with unstructured sparsity.

### SUMMARY

A method for multiplying two or more sparse matrices with another matrix is disclosed. The method includes receiving two or more sparse matrices each to be multiplied by a second matrix, assigning an identification flag to each of the sparse cells, wherein the flag represents to which of the two or more matrices said sparse cell belongs, left aligning each row in each of the two or more sparse matrices to a number of columns representing maximum non-sparse cells of said row in each of said two or more matrices, thus generating two or more associated left aligned matrices, compacting the two or more left aligned matrices into a single left aligned matrix, multiplying the single left aligned matrix by the second matrix. and using the identification flag as input to a multiplexer to direct output of the multiplication to a corresponding final output matrix associated with one of the two or more sparse matrices.

A method for multiplying a sparse matrix having one or more cells that are classified as sparse with a full matrix is also disclosed. The method includes receiving a sparse matrix to be multiplied by a full matrix, aligning each row in the sparse matrix based on a maximum number of non-sparse cells in each said row, thus generating a aligned matrix, displacing at least one cell from an original row of the aligned matrix into a row in a predetermined direction of the aligned matrix to thereby generate at least one new sparse column in said sparse matrix to thus critical path defined as number of non-sparse cells in a row with most non-sparse cells by discarding said at least one new sparse column, thus generating a critical-path-reduced matrix, and wherein the at least one displaced cell includes a flag identifying said cell has been displaced from the original row in the sparse matrix, and multiplying the critical-path-reduced matrix with the full matrix using a multiplier in a multiplier circuit row in the displaced position, wherein the multiplier product from each cell having a displacement flag is moved and accumulated to an accumulator within the multiplier associated with said original row along with the products of any undisplaced cells.

### BRIEF DESCRIPTION OF FIGURES

FIG. 1 is an example 4×4 matrix with row 0 (first row) having two cells, row 1 having only one cell, row 2 having 3 cells, and row 3 having only two cells.

FIG. 2 is a left-aligned matrix version of FIG. 1.

FIGS. 3a, 3b, 3c, and 3d are generic examples of single-step uni-directional displacement (SUDS), for improving sparsity of a matrix according to the present disclosure.

FIG. 4 is a schematic of hardware for SUDS, according to one embodiment of the present disclosure.

FIG. 5 is a graph of critical path distribution of four filer sub-matrix groups in ResNet50, which shows the distribution before and after the optimal assignment while scheduling four sparse filter sub-matrices for an intermediate layer in ResNet50.

FIGS. 6a, 6b, 6c, and 6d are matrices showing progression of cycling through rows with respect to the method of the present disclosure for a parameter k=3.

FIGS. 7a, 7b, 7c, 7d, 7e and 7f are matrices showing progression of cycling through rows with respect to the method of the present disclosure for the parameter k=2.

FIGS. 8a, and 8b are two sparse matrices each to be multiplied by another matrix (not shown).

FIG. 8c is the result of left aligned compaction of the matrices shown in FIGS. 8a and 8b prior to being multiplied by another matrix (not shown).

### DETAILED DESCRIPTION

For the purposes of promoting an understanding of the principles in the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel method and hardware that can improve matrix multiplication with unstructured sparsity in compute-intensive operations such as deep neural networks is presented herein. Towards this end, we seek to exceed the 2× improvement limit of 2:4 sparsity proposed in the prior art and efficiently capture the opportunity of 5-6× work reduction in unstructured filter sparsity. To achieve efficient unstructured filter (one-sided) sparsity, we disclose a novel methodology, herein referred to as Eureka, starting with the basic observation that a 4-1 multiplexers for 2:4 sparsity suffices to capture unstructured sparsity while maintaining operand stationarity (i.e., no extra hardware). A further extension of our observation is that a simply larger multiplexer (e.g., 16-1) suffices to allow the offline compaction of a larger sparse filter matrix into a smaller matrix to improve compute utilization without increasing output buffering. The sufficiency of the 2:4 sparsity hardware has not been observed before. However, the resultant load imbalance among the non-zero and vacant matrix cells, which cannot be packed arbitrarily while maintaining operand stationarity, considerably hurts performance. Further, while 2:4 sparsity's uniformity allows for smooth systolic operation without any pipeline bubbles, unstructured sparsity's load imbalance-induced timing non-uniformity induces bubbles. To address these issues we make the following contributions:
1) To achieve better load balance, our key insight is that a slight weakening of output stationarity achieves load balance most of the time while incurring only a modest hardware overhead. Accordingly, we disclose single-step unidirectional displacement (SUDS), in which a filter element's multiplication can either occur in its original position or be displaced to a vacant multiply accumulate (MAC) in the adjacent row below (in a wraparound manner) while the accumulation occurs in the original row to restore output stationarity. Because the filters do not change during inference, we compact the filters and apply SUDS offline before inference. SUDS adds only two 2-1 multiplexers and a carry-save adder with floating-point (FP) mantissa alignment per MAC.
2) An optimal polynomial-time algorithm for SUDS work assignment. Our correctness proof also enables SUDS hardware overhead reduction.

Altogether, Eureka improves performance by 4.8× and 2.4×, and reduces energy by 3.1× and 1.8× over dense and 2:4 sparse implementations, respectively. To achieve these improvements, at each MAC we (1) replace Ampere's 4-1 multiplexer with a 16-1 multiplexer and (2) add two 2-1 multiplexers and a carry-save adder with FP mantissa alignment for area and power overheads of 6% and 11.5%, respectively, over Ampere.

Matrix multiplication can be implemented using two fundamentally different methods. Inner product method computes the dot product of every pair of row and column vectors, from the first and second input matrices, respectively. The computation can be viewed as a i, j, k ordered nesting of loops in the classical three-loop matrix multiplication algorithm with the innermost k loop (within square brackets) computing the inner product of the i^{th} row and j^{th} column. In this type of product, a rows of a first matrix is multiplied by columns of a second matrix. For example, suppose the first matrix is A having dimensions of 3×2 and the second matrix is B having dimensions of 2×3. The dot product (also known as the inner product) results in a matrix C which is 3×3 as shown below-:

$$A = [ \begin{matrix}{a}_{11} & {a}_{12} \\ {a}_{21} & {a}_{22} \\ {a}_{31} & {a}_{32}\end{matrix} ] , B = [ \begin{matrix}{b}_{11} & {b}_{12} & {b}_{13} \\ {b}_{21} & {b}_{22} & {b}_{23}\end{matrix} ] ,$$

$$A \cdot B = C = [ \begin{matrix}{a}_{11} \cdot {b}_{11} + {a}_{12} \cdot {b}_{21} & {a}_{11} \cdot {b}_{12} + {a}_{12} \cdot {b}_{22} & {a}_{11} \cdot {b}_{13} + {a}_{12} \cdot {b}_{23} \\ {a}_{21} \cdot {b}_{11} + {a}_{22} \cdot {b}_{21} & {a}_{21} \cdot {b}_{12} + {a}_{22} \cdot {b}_{22} & {a}_{21} \cdot {b}_{13} + {a}_{22} \cdot {b}_{23} \\ {a}_{31} \cdot {b}_{11} + {a}_{32} \cdot {b}_{21} & {a}_{31} \cdot {b}_{12} + {a}_{32} \cdot {b}_{22} & {a}_{31} \cdot {b}_{13} + {a}_{32} \cdot {b}_{23}\end{matrix} ]$$

The inner product can be represented by:

$$∀ i , ∀ j , [ ∀ k , C ( i , j ) ← A ( i , k ) \times B ( k , j ) + C ( i , j ) ]$$

The outer product is typically denoted by ⊗ and is based on a cross product of only the matching i^{th} column and the i^{th} row vectors, from the first and second matrices, respectively. Accumulating the partial matrices of different column-row pairs gives the final output matrix. The outer product method can be viewed as a k, j ordered nesting of loops in the three-loop matrix multiplication algorithm. Because multiplication and addition are commutative and associative, any permutation of the i, j, k loop order is equivalent. The inner two loops (within the square brackets) for a given fixed value of k iterates over the kth column of A and the k^{th} row of B to yield a partial matrix. For the above example, the outer product of A⊗B is thus:

$$A ⊗ B = C = [ \begin{matrix}{a}_{11} \cdot [ \begin{matrix}{b}_{11} & {b}_{12} & {b}_{13} \\ {b}_{21} & {b}_{22} & {b}_{23}\end{matrix} ] & {a}_{12} \cdot [ \begin{matrix}{b}_{11} & {b}_{12} & {b}_{13} \\ {b}_{21} & {b}_{22} & {b}_{23}\end{matrix} ] \\ {a}_{21} \cdot [ \begin{matrix}{b}_{11} & {b}_{12} & {b}_{13} \\ {b}_{21} & {b}_{22} & {b}_{23}\end{matrix} ] & {a}_{22} \cdot [ \begin{matrix}{b}_{11} & {b}_{12} & {b}_{13} \\ {b}_{21} & {b}_{22} & {b}_{23}\end{matrix} ] \\ {a}_{31} \cdot [ \begin{matrix}{b}_{11} & {b}_{12} & {b}_{13} \\ {b}_{21} & {b}_{22} & {b}_{23}\end{matrix} ] & {a}_{32} \cdot [ \begin{matrix}{b}_{11} & {b}_{12} & {b}_{13} \\ {b}_{21} & {b}_{22} & {b}_{23}\end{matrix} ]\end{matrix} ]$$

The outer product can be represented by:

$$∀ k , [ ∀ i , ∀ j , C ( i , j ) ← A ( i , k ) \times B ( k , j ) + C ( i , j ) ]$$

A key aspect is effectively utilizing the MACs with low buffering and data movement, as determined by the hardware dataflow. A well-known approach is to hold stationary one of the matrices' elements in the MACs and minimally move the remaining matrices. In an input-stationary dataflow, each MAC holds an input element (or a group of input elements) of one matrix. The other input matrix is broadcast to the MAC to generate the partial output element. The partial output elements are transferred from one MAC to the next (spatially) for accumulation to compute the final output element. Alternatively, the four marked MACs are interconnected using a reduction tree to enable spatial reduction. Thus, for the input-stationary dataflow, an inner product method allows for minimal data transfers. In contrast, in an output-stationary dataflow, each output element (or a group of output elements) is generated in a MAC in place by broadcasting both of the corresponding input vectors. Each partial output element is accumulated in place over time to produce the final output element. Thus, the output-stationary dataflow supports the outer product method with minimal data transfers. Although there is a reduction tree in the input-stationary approach and two-directional broadcast in the output-stationary design, the approaches are similar in terms of overall cost.

Matrix multiplication is often tiled and parallelized on many MACs. The tiles can be of various shapes (e.g., row, square, or column). In addition, a tile of one input matrix can be multiplied with multiple tiles of the other input enabling enormous reuse. The tiles can be nested with either method at each nesting level, allowing for many hybrid methods.

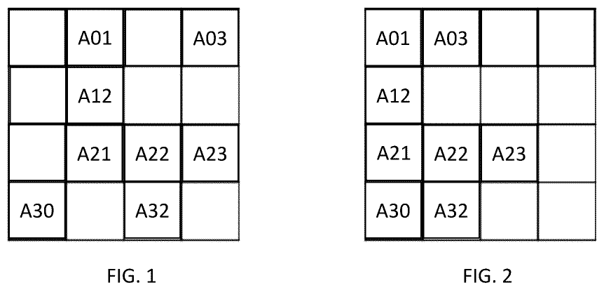

However, in matrix multiplication, one of the matrices may have a plurality of zeros (Os) dispersed throughout the matrix, referred to herein as sparsity. The sparsity may be structured or unstructured. The present disclosure is mainly concerned with unstructured sparsity. FIG. 1 shows an example of such an unstructured sparsity. In the example shown in FIG. 1, which is an example 4×4 matrix with row 0 (first row) having two cells, row 1 having only one cell, row 2 having 3 cells, and row 3 having only two cells. The flexibility provided by the 4-1 multiplexers is sufficient for unstructured sparsity where the second input for the (n,m)^{th} MAC has a 4-1 choice among all four rows of the second input matrix's n^{th} column. Unfortunately, the unpredictability of the non-zero counts, as opposed to 2:4 sparsity's exactly two non-zeros in every four dense values, causes considerable load imbalance and compute underutilization. For instance, with 87.5% observed at moderate pruning in ResNets, each 4×4 matrix has around two non-zero elements on average. If the two non-zeros are in the same column (best case), the multiplication can finish in just one cycle but achieve only 50% utilization. In the worst case, where the non-zeros are in the same row, utilization drops to just 25%.

We start off with well-known, offline matrix compaction where two left-aligned, unstructured-sparse matrices are compacted along the rows, which improves utilization, as shown in FIG. 2 which represents a left-aligned matrix version of FIG. 1. Thus FIG. 2 represents sparsity of FIG. 1 compacted so that cells are left aligned.

We extend our basic observation with the point that replacing Ampere's 4-1 multiplexer with a larger multiplexer suffices for this compaction without increasing output buffering (e.g., 8-1 or 16-1 multiplexer for compacting 4×8 or 4×16 matrices into a 4×4 matrix). To see this extension, observe that each column of the compacted matrix is broadcast to the compute array. However, given that 8 (or 16) columns are compacted instead of 4 columns as done in 2:4 sparsity, we need 8-1 (or 16-1) multiplexer instead of 2:4 sparsity's 4-1 multiplexer.

Despite matrix compaction, load imbalance exists due to irregularity of unstructured sparsity. The non-zero and vacant cells of the compacted matrix cannot be packed arbitrarily while maintaining output stationarity, leading to MAC idling. To address this issue, we disclose: (1) single-step uni-directional displacement (SUDS) for moving the multiplication work to a vacant MAC in the adjacent row below, and (2) an optimal work assignment algorithm for SUDS, as discussed below.

While matrix compaction improves utilization by compacting the filters along the rows as discussed above, there is no compaction along the columns. Thus, compaction is a hit or miss approach: a compacted matrix where one row is much longer than the others would incur severe under-utilization. While simply distributing the values among the rows would achieve better utilization, such arbitrary distribution would disrupt output stationarity leading to high hardware, area, and energy overheads. Our key innovation is that a slight relaxation of output stationarity achieves load balance in most cases while incurring low overheads. Accordingly, we disclose single-step uni-directional displacement (SUDS), carried out offline in software, in which a filter element's multiplication can either occur in its original position or be displaced to a vacant MAC in the adjacent row below in a wraparound manner while the accumulation occurs in the original row to restore output stationarity.

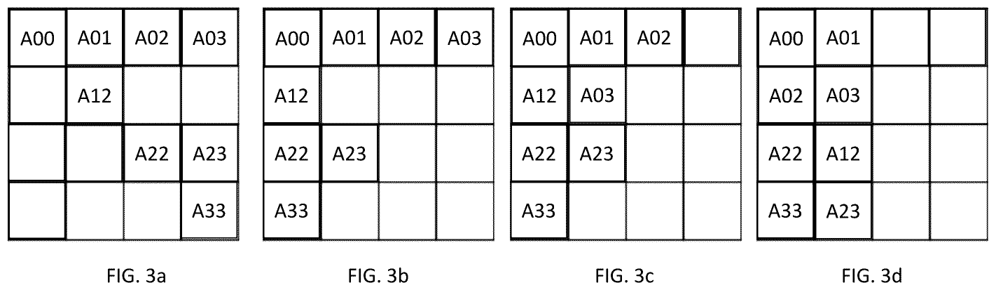

FIGS. 3a-3c shows an example of SUDS. The first row of the sparse matrix A initially has four values in its first row (see FIG. 3a), while the other rows have two or fewer. Referring to FIG. 3b, left alignment of the matrix shown in FIG. 3a is provided. Referring to FIG. 3c, a value from the first row is displaced to an adjacent MAC below, reducing the cycle count from four to three. The partial product generated in the bottom MAC is accumulated at the original MAC to restore output stationarity. It should be noted that any of the four cells in the first row could have been shifted down by one row. The displacement in FIG. 3c is not considered to be optimal as the first row has three cells occupied, while the second and third rows have two cells occupied, and the last row has only one cell. This level of optimization is referred to herein as “Greedy Displacement.”

A key correctness point is that in the outer product method without any displacement, the partial products for all the elements in a row i of a filter matrix are accumulated at the same row i of the output matrix. Consequently, a displaced value's partial products can be accumulated at the partial products of the row above, irrespective of the column to which the value is displaced. Though restricted to displacing work only to the row below the original position, SUDS is powerful because multiple elements can be displaced achieving good load balance. As an example, FIG. 3d shows a perfectly load-balanced result. Two rules have been implemented to arrive at FIG. 3d: 1) No cell can be displaced more than one row in a wraparound manner (i.e., cells from the bottom row can be displaced from bottom row to the top row); 2) determining the number of cells and rows can provide an initial goal of optimality (i.e., here there are 8 cells occupied, and there are 4 rows, so it may be possible to arrive at 2 cells per row). However, the second rule may run afoul to combinatorial explosion.

Though the multiplication for a displaced value occurs at the MAC below, the accumulation of the partial product occurs at the displaced value's original position to restore output stationarity.

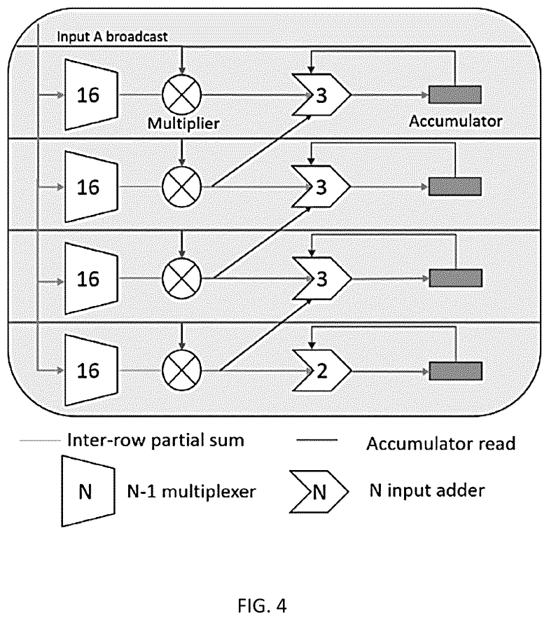

In hardware, we add extra wires for the displaced partial product to return to the original MAC above (as shown in FIG. 4 which is a schematic of hardware for SUDS, according to one embodiment of the present disclosure). In the figure, there are four possibilities for two vertically-adjacent MACs: (1) neither of the values they are multiplying was displaced (e.g., A₂₂ and A₃₃ in FIG. 3d), (2) the top value was not displaced but the bottom value was (from above) (e.g., A₀₀ and A₀₂, respectively), (3) the top value was displaced but the bottom value was not (e.g., A₀₂ and A₂₂, respectively), and (4) both values were displaced (e.g., A₀₃ and A₁₂). The first case requires no change. In the second case, the two partial products (from the top and bottom MACs) belong to the same output element and are accumulated at the top MAC, performing a three-input addition. In the third case, the top MAC's product goes to the MAC above leaving the top MAC's adder unused (the bottom value stays at the bottom MAC). In the final case, the top MAC's product goes up one hop and the bottom MAC's product is accumulated at the top MAC. Hence, we need a three-input adder in each MAC.

The three-input adder's inputs are the local product, local accumulator, and the product from below (see FIG. 4, which is a schematic of the SUDS hardware with one MAC output shown). In the first case above, the third input is set to zero. In the second case, all three inputs are valid. In the third case, no addition is done. And in the final case, the first input is set to zero. Therefore, the first and third inputs need a 2-1 multiplexer each. As in the case of 2:4 sparsity, the relevant multiplexers of a row share their control. The three-input addition can be implemented as a carry-save adder to reduce the three values to two (the sum and carry) followed by a full adder. To indicate to the hardware whether a value is displaced requires only one bit per value, in addition to Eureka's 4-bit metadata for compaction.

SUDS can cut the critical path, the longest row, by 50% even for the worst case. For example, in a worst-case sparse matrix that has a single row with four values, utilization improves by 2× by displacing two values from the original row to the row below. In general, we need to find the assignment of the values across the rows that achieves the best utilization. As mentioned before, because the filters do not change for inference, this work assignment is done offline. Below we disclose our optimal work assignment algorithm.

A naive, greedy algorithm may not be able to generate the optimal work assignment. For example, a greedy algorithm that simply finds an empty anti-diagonal slot in the compacted matrix can fail to achieve the minimum critical path. As shown in FIG. 3c, while considering the first row the algorithm checks only the second row and finds one empty slot. While considering the second row checks only the third row and finds no slots. Thus, the algorithm produces a three-column matrix after displacement. However, the optimum is a two-column matrix, as shown in FIG. 3d. Thus, we need an algorithm to achieve the optimal work assignment, as provided below:

Algorithm 1 Algorithm for the decision problem

Input: Sparse Matrix M, number K
Output: Sparse Matrix O with max row length ≤ K

| | |
|---|---|
| 1: | slack_rows ← { } |
| 2: | for each row in M do |
| 3: | if (length(M[row]) ≤ K then |
| 4: | slack_rows.append(row) |
| 5: | end if |
| 6: | end for |
| 7: | for each row in slack_rows do |
| 8: | O ← M |
| 9: | i ← p − 1 |
| 10: | while i ≥ 0 do |
| 11: | row_{above} ← row − 1 (mod p) |
| 12: | C ← length(O[row]) |
| 13: | C_{above} ← length(O[row_{above}]) |
| 14: | slack ← K − C |
| 15: | n_disp ← min(C_{above}, slack) |
| 16: | //Displace n_disp elements from row_{above} to row |
| 17: | O[row] ← displace(O[row_{above}], n_disp) |
| 18: | row ← row_{above} |
| 19: | if length(O[row]) > K then |
| 20: | Break to next slack row |
| 21: | end if |
| 22: | i ← i − 1 |
| 23: | end while |
| 24: | return O // found an optimal solution |
| 25: | // no need to try more slack rows |
| 26: | end for |
| 27: | return No solution |

A key challenge in finding the optimum is that while a row may have some room, the row above may need to displace more than the room available so that the row with the room itself may have to displace to the row below to make more room for the row above. And so on, across all the rows. For example, suppose the first row had three elements (A₀₀, A₀₁, A₀₂), the second row had four elements (A₁₀, A₁₂, A₁₂, A₁₃), the third row had no cells, and the last row had only one cell (A₃₀). While, there are still 8 cells and 4 rows, an optimal solution of 2 cells per row is not possible without violating the first rule, discussed above of not displacing cells more than one row.

Thus, it is not easy to decide how much to displace to the next row because the next row's length may change based on how much the next row itself displaces later. Therefore, we employ a two-step process where we first step finds feasible work assignments that can fit all the rows within a given length and then search through the feasible solutions to find the optimum solution.

For the first step, we define the following decision problem:

Definition 1. Given a sparse matrix M of dimension p×q and a number K, is there an assignment such that each value of row i either stays in the i^{th} row or is displaced to the i+1^{th} (mod p) row (i.e., wraparound) and the final matrix's longest row (i.e., the critical path) is less than K? Additionally, we define the following two terms:
Slack rows: A row in M with a length C such that K≥C.
Base rows: A row that does not displace any elements to the adjacent row below even in a wraparound manner.

With these definitions, we see that a slack rows can accept displaced values from the previous row. However, a slack row may itself displace some of its values to the adjacent row to satisfy the decision problem. We also define that a satisfying assignment is minimal if there are no redundant displacements. An example redundant displacement is one that displaces exactly one value in each row without changing the longest row length.

If the decision problem has a minimal solution, then there is at least one slack row that is also a base row (i.e., no value displaced to the adjacent row). We prove this statement by contradiction. Let us assume that a minimal solution exists with no base rows so that each row has displaced at least one value. However, this solution is not minimal as there is a redundant movement. Hence a minimal solution must contain at least one base row. In addition, the base row is always a slack row; otherwise, the row length would exceed K such that the solution would not satisfy the decision problem.

Algorithm 1 finds a minimal solution for the decision problem if the solution exists. Because we do not know which slack row is a base row, the algorithm tries each slack row as a base row. The algorithm starts at a slack row and at each row greedily fills up the available slack by displacing from the adjacent row above before moving to the row above. If this process results in a negative slack for any row (i.e., row length>K), then the algorithm moves on to try the next slack row. Only a truly base row would lead to a solution. The time complexity of this offline algorithm is O(p²).

Given this algorithm to find a minimal solution for the decision problem, we extend the algorithm to determine the optimal longest row length Kopt. To that end, the extension tries every K between the lower bound of ceil (count (M)/p) where count is the number of values in M (the longest row cannot be shorter than this bound) and the upper bound of q. For larger matrices, the trials can be binary-searched between these bounds leading to a complexity of O(p² log q). Using the row lengths of the minimal solution with Kopt, we displace the values of M to produce the displaced filter matrix O.

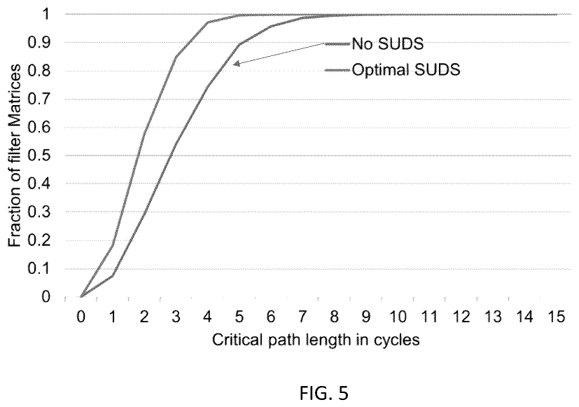

The SUDS assignment compresses the sparse sub-matrices leading to two key changes in the sub-matrix critical path distribution: (1) more sub-matrices have shorter critical paths and (2) the critical path distribution has shorter range and lower variation. FIG. 5, which is a graph of critical path distribution of four filer sub-matrix groups in ResNet50, shows the distribution before and after the optimal assignment while scheduling four sparse filter sub-matrices for an intermediate layer in ResNet50.

Finally, although the cases for small 4×4, 4×8 matrices can be enumerated exhaustively, especially if offline, the above algorithm is scalable to larger sizes due to it polynomial time complexity. A key observation from our proof is that the number of displacements needed is just p−1 for a p×q matrix because the base row does not displace. Consequently, the hardware can avoid SUDS support in one of the MACs. Accordingly, we offline rotate the matrix so that the base row is placed always on the last ((p−1)^{th}) MAC row avoiding expensive wraparound wires from the last MAC row to the first (FIG. 4). Also, the last row of MACs can use two-input, instead of three-input, adders. For this rotation, we add a two-bit field, indicating the rotation amount, to each filter matrix for adjusting the software index while loading the filter matrix into the GPU and storing the output matrix into memory. The rest of the computation remains oblivious of this rotation.

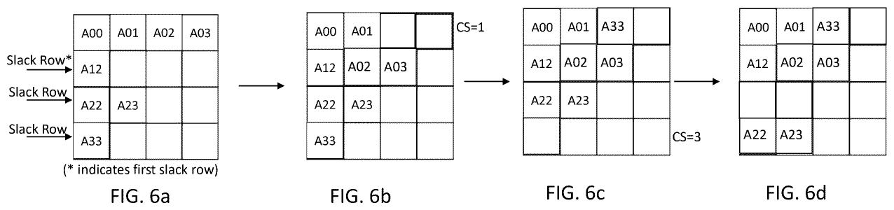

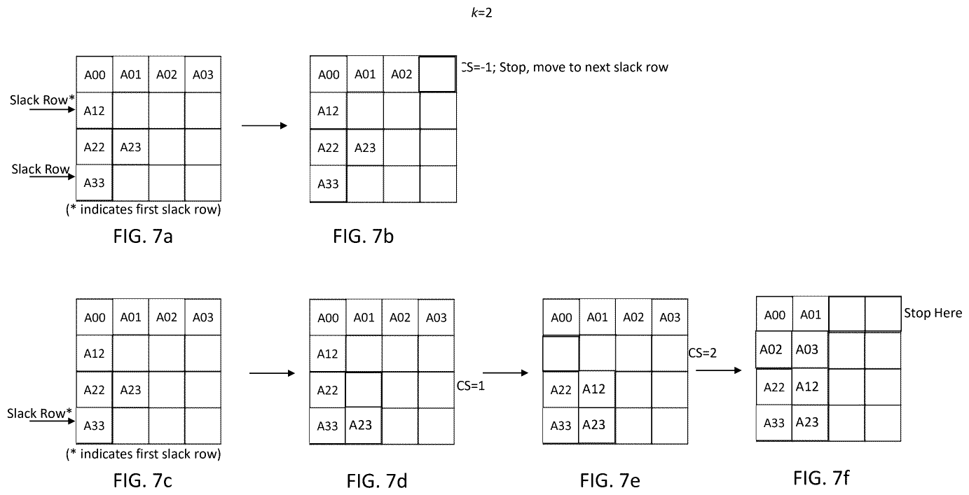

To better elucidate the SUDS operation, reference is made to FIGS. 6a-6d and FIGS. 7a-7f which are two figures showing progression of cycling through rows and with respect to the following procedure:

As discussed above the following definition are provided:
1) Define kᵢ as between Kₘₐₓ and Kₘᵢₙ, where Kₘₐₓ-maximum (number of cells in any row)−1, and Kₘᵢₙ=Ceiling (maximum number of non-sparse cells/number of rows). Reference is made to FIG. 6a where the left aligned matrix shown in FIG. 3b is reproduced. Again, there are four rows (top row: row 0, row 1, row 2, and bottom row: row 3). For this matrix, Kₘₐₓ is determined by noting row 0 has the greatest number of cells (4 cells), thus Kₘₐₓ is 4-1 or 3. Kₘᵢₙ is defined as the ceiling of maximum number of non-sparse cells (8) divided by the number of rows which is 4, equals 2. The function ceiling means and number, e.g., greater than 1.000, but smaller than 1.999, has a ceiling of 2. Therefore, kᵢ is between 3 and 2. FIGS. 6a-6d are for kᵢ=3.
2) Next, we define slack rows which are defined as rows with lengths≤kᵢ, which for the FIGS. 6a-6d are rows 1, 2, and 3. Additionally, we defined current slack (CS) which represents the amount of slack in a row after cells have been displaced to an adjacent row.
3) Next we defined the term Displaced Row, which represents a row that has had one or more cell displaced to a an immediate adjacent row.
4) Next we define as a general term slack of a row:
   i. A row has a negative slack (i.e., the number of non-sparse cells is greater than kᵢ(i.e., ≥3);
   ii. The row has a zero slack (i.e., the number of remaining non-sparse cells is equal kᵢ(i.e., =3); or
   iii. The row has a positive slack (i.e., the number of remaining non-sparse cells is less than kᵢ(i.e., ≤3).
5) Next, in a outer loop, the method of the present disclosure cycles through each kᵢ (any order where kᵢ is chosen between Kₘₐₓ and Kₘᵢₙ. It should be noted that many approaches can be taken to accomplish this cycling, e.g., sorted based on descending order, sorted based on ascending order, a binary division order, a random order, a predetermined order, etc. The point is that the method of the present disclosure is agnostic as to how kᵢ is chosen between Kₘₐₓ and Kₘᵢₙ. For the sake of example, we choose kᵢ is chosen as 3 (FIGS. 6a-6d) and then 2 (FIGS. 7a-7f).
6) Thus in this outer loop, for each value of kᵢ:
   a. The slack rows are identified. As indicated in FIG. 6a, three slack rows are identified (row 1, row 2, and row 3), based on the above definition of slack row, since in each of these rows the number of cells is ≤3.
   b. Next we cycle through the slack rows (SRᵢ) in a first inner loop:
      i. We start with one slack row as the starting slack row. We choose row 1 as the starting slack row, however, any of the 3 rows could have been chosen as the starting slack row.
      ii. From the first slack row, we cycle through all the rows (Rᵢ) in a second inner loop until reaching a row immediately prior to the first slack row:
         1. Next, cells from a row immediately adjacent each Rᵢ (initially, in this case from row 0) is displaced into the Rᵢ if Rᵢ has a positive slack. As the first cycle in the second inner loop, Rᵢ is the slack row and therefore has a positive slack. Whenever there is a positive slack, the number of cells displaced from the immediate adjacent row is the maximum number of cells such that after displacement the number of cells into the row where cells are displaced Rᵢ does not exceed kᵢ(i.e., ≤3). Thus we displace 2 cells from row 0 into row 1 as shown in FIG. 6b. It should be noted that while cells A02 and A03 were displaced, any other combination of two cells from row 0 could have been displaced.
         2. Next, we examine the Displaced Row (i.e., row 0) to determine current slack (CS) of that row. Three possibilities exists:
         a. Negative slack: in which case the method jumps out of the second inner loop and proceeds to the next slack row (SRᵢ);
         b. Zero slack: in which case the method cycles to the next row (Rᵢ) without any displacement; or
         c. Positive slack: in which maximum number of cells are displaced from the next immediately adjacent row.
         d. In this case, row 0 has a CS of 1 (i.e., kᵢ−2). Thus, the method cycles to the displaced Row and displaces one cell from row 3 which is a wrap-around row to the row 0, thus leaving row 3 with a CS of 3 (i.e., positive).
         e. Next the second inner loop cycles to row 3 since row 3 has a positive slack, where both cells are displaced from row 2.
         f. Since the Displaced Row is now row 2, and row 2 is one prior to reaching the first slack row, the method declares kᵢ=3 as a potential acceptable solution because: no negative slacks were encountered and thus jumps out of the outer loop to the next kᵢ. If however, the method cycled through all slack rows as part of the first inner loop, then the method would declare there is no solution for the kᵢ (in this case 3).

Referring to FIGS. 7a-7f, the above-procedure is shown for kᵢ=2. Of note, in FIG. 7b, after displacing one cell from row 0 to row 1 as the starting slack row, the Displaced Row (row 0) results in a negative slack. This results jumping out of the first inner loop to the next slack row, shown in FIG. 7c. During the cycling of rows until we get to row 0 which is the last row in the second inner loop as one prior to the starting slack row, shown in FIG. 7f, we did not encounter any negative slack, thus the method declares kᵢ=2 also as potential solution. However, since kᵢ=2 is less than kᵢ=3, the reduction in sparsity is better thus the best solution is presented in FIG. 7f for kᵢ=2. It should be noted that while in FIGS. 6a-6d and 7a-7f, we show left alignment, no such alignment is needed after displacement as the final augmented matrix (e.g., shown in FIG. 7f) can be left aligned. By left aligning, one can discard the two right most columns thus obtaining a 4×2 critical-path-reduced matrix vs. the original 4×4 sparse matrix.

It should be appreciated that while in the figures provided herein, an upward movement is shown during the cycling through each row with wrap-around once reaching the top row to the bottom row, no such limitation is intended. In other words, the cycling can be done with a downward movement with a wrap-around to the top row once reaching the bottom row.

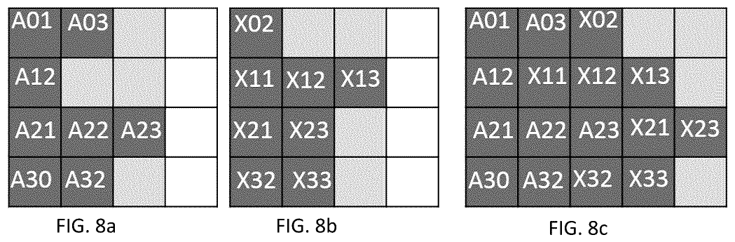

While a significant amount of efficiency is achieved by SUDS, as discussed above compaction can also provide additional sparsity reduction. Suppose there are two or more sparse matrices as shown in FIGS. 8a and 8b each to be multiplied by another matrix. Instead of carrying out the multiplication of each of the two sparse matrices, according to the present disclosure these two sparse matrices can be left aligned into one sparse matrix shown in FIG. 8c. Now, the sparse matrix of FIG. 8c can be multiplied by the other matrix in a single multiplication. To carry out this multiplication, each cell in the compaction carries a binary flag describing from which sparse matrix it originated. For only two sparse matrices to be compacted, a single bit (I/O) flag is sufficient to describe if the cell in the compacted matrix came from the first or the second matric. However, if there are four such sparse matrices, each cell in the compacted matrix would require a two-bit flag to describe from which sparse matrix it originated, and so on. These flags can be used by multiplexers to properly position data from each cell in the correct position in the multiplier. Therefore, for a small cost associated with hardware, there can be a significant improvement in sparsity by compaction.

Additionally, while not shown, SUDS can be combined with scheme shown in FIGS. 8a-8c to even further improve sparsity. That is, each of the sparse matrices to be multiplied by another matrix can be first treated by SUDS, and then left aligned compacted prior to be multiplied by the other matrix. Alternatively, the sparse matrices can be compacted into one left aligned compacted matrix and then treated by SUDS prior to being multiplied.

It should be appreciated that while alignment discussed herein is based on a left alignment, the scope of the present disclosure also covers right alignment. Therefore, wherever left alignment is needed, that alignment can be replaced with a right alignment.

Those having ordinary skill in the art will recognize that numerous modifications can be made to the specific implementations described above. The implementations should not be limited to the particular limitations described. Other implementations may be possible.

1. A method for multiplying two or more sparse matrices each having one or more cells that are classified as sparse with a full matrix, comprising:
receiving two or more sparse matrices each to be multiplied by a second matrix;
assigning an identification flag to each of the sparse cells, wherein the flag represents to which of the two or more matrices said sparse cell belongs;
aligning each row in each of the two or more sparse matrices to a number of columns representing maximum non-sparse cells of said row in each of said two or more matrices, thus generating two or more associated aligned matrices;
compacting the two or more aligned matrices into a single aligned matrix;
multiplying the single aligned matrix by the second matrix; and
using the identification flag as input to a multiplexer to direct output of the multiplication to a corresponding final output matrix associated with one of the two or more sparse matrices.

2. The method of claim 1, wherein sparsity of each of the two or more sparse matrices are determining apriori based on one or more cells of each of the two or more sparse matrices are at or below a predetermined threshold.

3. The method of claim 1, wherein the identification flag includes sufficient bits to provide full address for each of the two or more sparse matrices.

4. The method of claim 1, wherein the multiplication is an outer product, wherein each cell of jth column of the single left aligned matrix (Sᵢⱼ, where i=1 to maximum number of rows, and j=1 to maximum number of columns) is multiplied one by one by all the cells in jth row of the second matrix (Fₖ₁, where k=1 to maximum number of rows and 1=1 to maximum number of columns) and results are placed in rows of corresponding interim output matrices based on value of the identification flags, thus generating as many interim output matrices as columns in the single aligned matrix, wherein cells in each of the interim output matrices are accumulated to generate a final output matrix.

5. The method of claim 4, wherein the cells of each column of the second matrix (Fₖ₁) are made available to multiply circuits via a 1-to-n multiplexer, where n is represents number of rows of the second matrix.

6. The method of claim 1, wherein the alignment of each row is based on a left alignment.

7. The method of claim 1, wherein the alignment of each row is based on a right alignment.

8. A method for multiplying a sparse matrix having one or more cells that are classified as sparse with a full matrix, comprising:
receiving a sparse matrix to be multiplied by a full matrix;
aligning each row in the sparse matrix based on a maximum number of non-sparse cells in each said row, thus generating a aligned matrix;
displacing at least one cell from an original row of the aligned matrix into a row in a predetermined direction of the aligned matrix to thereby generate at least one new sparse column in said sparse matrix to thus critical path defined as number of non-sparse cells in a row with most non-sparse cells by discarding said at least one new sparse column, thus generating a critical-path-reduced matrix, and wherein the at least one displaced cell includes a flag identifying said cell has been displaced from the original row in the sparse matrix; and
multiplying the critical-path-reduced matrix with the full matrix using a multiplier in a multiplier circuit row in the displaced position, wherein the multiplier product from each cell having a displacement flag is moved and accumulated to an accumulator within the multiplier associated with said original row along with the products of any undisplaced cells.

9. The method of claim 8, wherein sparsity of each of the two or more sparse matrices are determining apriori based on one or more cells of each of the two or more sparse matrices are at or below a predetermined threshold.

10. The method of claim 8, wherein the step of displacing at least one cell includes:
assigning NPᵢ as the maximum number of non-sparse cells in ith row, where i=1 to maximum number of rows;
for said aligned matrix, assigning parameters Kₘₐₓ as Maximum (NPᵢ, where i=1 to maximum number of rows)−1, and Kₘᵢₙ as a ceiling of a ratio of number of non-sparse cells in the sparse matrix to total number of rows;
finding a value kᵢ between Kₘₐₓ to Kₘᵢₙ, wherein:
for each kᵢ:
i) in the aligned matrix identifying one or more rows as slack rows (Srᵢ) if said row has fewer non-sparse cells than kᵢ,
ii) for each Srᵢ, cycling through each row according to a first direction starting from said Srᵢ and ending at a row before the Srᵢ, displacing a maximum number of cells from an immediate adjacent row to Srᵢ and a decreasing number of cells from increasingly farther adjacent rows, followed by aligning said adjacent rows (Displaced Rows) such that a) after displacement, total number of non-sparse cells in each said row do not exceed kᵢ, b) no displacement occurs from adjacent rows to Srᵢ farther than a predetermined displacement number, and c) each displaced cell is flagged with an identification flag indicating said cell is displaced from an immediate adjacent row, thus converting each Displaced Row into one of a) a negative slack row wherein number of remaining non-sparse cells is greater than kᵢ, thereafter advancing to next Srᵢ, b) a zero slack row wherein number of remaining non-sparse cells is equal to kᵢ, thereafter advancing to next row without any displacement, and c) a positive slack row wherein number of remaining non-sparse cells is less than kᵢ, thereafter displacing a maximum number of cells from a Displaced Row into said row, wherein if during cycling through each Srᵢ, no negative slack row is encountered, then the process for the current kᵢ exits with an augmented aligned matrix with the critical path of kᵢ, and if each Srᵢ resulted in encountering a negative slack, then the process for the current kᵢ exits with said kᵢ identified as producing no potential solution.

11. The method of claim 10, wherein a kᵢ is chosen to minimize the critical path which is the number of non-sparse cells in the longest row in said augmented aligned matrix to generate an optimal critical-path-reduced matrix.

12. The method of claim 11, wherein a first said augmented aligned matrix has shorter critical path for a first kᵢ than a second said augmented aligned matrix for a second kᵢ, wherein the first kᵢ is smaller than the second kᵢ.

13. The method of claim 11, wherein the first direction is upward wherein the cycling is configured to wrap around from a top row to a bottom row.

14. The method of claim 11, wherein the first direction is downward wherein the cycling is configured to wrap around from a bottom row to a top row.

15. The method of claim 11, wherein order of selection of kᵢ between Kₘₐₓ and Kₘᵢₙ is based on one of i) a predetermined order; ii) a random order, and iii) a combination thereof.

16. The method of claim 8, wherein the multiplication is an outer-product multiplication.

17. The method of claim 16, wherein each cell of jth column of the critical-path-reduced matrix (Sᵢⱼ, where i=1 to maximum number of rows, and j=1 to maximum number of columns) is multiplied one by one by all the cells in jth row of the second full matrix (Fₖ₁, where k=1 to maximum number of rows and 1=1 to maximum number of columns) wherein cells with identification flags indicative of having been displaced are placed in multiplier circuit rows of corresponding interim output matrices associated with the displaced row but the multiplier product is accumulated in the original row of the displaced cell along with the products of any undisplaced cells, thus generating as many interim output matrices as columns in the critical-path-reduced matrix, wherein cells in each of the interim output matrices are accumulated to generate a final output matrix.

18. The method of claim 17, wherein the cells of each column of the full matrix (Fₖ₁) are made available to multiply circuits via a 1-to-n multiplexer, where n represents number of rows of the full matrix.

19. The method of claim 8, wherein the alignment of each row is based on left alignment.

20. The method of claim 8, wherein the alignment of each row is based on right alignment.
